(19) United States
(12) Patent Application Publication
(10) Pub. No.: US 2010/0260396 A1
(43) Pub. Date: Oct. 14, 2010

(54) INTEGRATED SEGMENTATION AND CLASSIFICATION APPROACH APPLIED TO MEDICAL APPLICATIONS ANALYSIS

(76) Inventors: Achiezer Brandt, Rehovot (IL); Meirav Galun, Rehovot (IL); Ronen Ezra Basri, Rehovot (IL); Ayelet Akselrod-Ballin, Kiryat Ono (IL); Moshe John Gomori, Jerusalem (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 12/159,668

(22) PCT Filed: Dec. 28, 2006
(86) PCT No.: PCT/US06/49536

§ 371 Date: Jun. 17, 2010

Related U.S. Application Data
(60) Provisional application No. 60/755,393, filed on Dec. 30, 2005.

(51) Int. Cl. G06T 7/00

(52) U.S. Cl. 382/131

(57) ABSTRACT

A novel multiscale approach that combines segmentation with classification to detect abnormal brain structures in medical imagery, and demonstrate its utility in detecting multiple sclerosis lesions in 3D MRI data. The method uses segmentation to obtain a hierarchical decomposition of a multi-channel, anisotropic MRI scan. It then produces a rich set of features describing the segments in terms of intensity, shape, location, and neighborhood relations. These features are then fed into a decision tree-based classifier, trained with data labeled by experts, enabling the detection of lesions in all scales. Unlike common approaches that use voxel-by-voxel analysis, our system can utilize regional properties that are often important for characterizing abnormal brain structures. Experiments show successful detections of lesions in both simulated and real MR images.

### BACKGROUND OF THE INVENTION

1. Field of the Invention

The present invention relates to a method, apparatus and computer readable medium that involves a novel multiscale system that combines segmentation with classification to detect abnormal or anatomical body structures in medical applications in general, and more particularly, in medical imagery, and still more particularly, brain structures in medical imagery.

2. Prior Art

Identifying 3D body structures, such as, 3D brain or other tissue or bone structures, in medical applications in general and more specifically in medical imagery, particularly in MRI (Magnetic Resonance Imaging) scans, is important for early detection of tumors, lesions, and abnormalities, with applications in diagnosis, follow-up, and image-guided surgery. Computer aided analysis can assist in identifying such structures, and in particular, brain, other tissue and bone structures, extract quantitative and qualitative properties of structures, and evaluate their progress over time. In this document a novel method and apparatus for detecting abnormal or anatomical tissue or bone structures, such as, brain structures is presented, focusing on 3D MRI brain data containing scans of multiple sclerosis (MS) patients as a specific example.

Automatic detection of abnormal brain structures, and particularly MS lesions, is difficult. Abnormal structures exhibit extreme variability. Their shapes are deformable, their location across patients may differ significantly, and their intensity and texture characteristics may vary. Detection techniques based on template matching [4]¹ or more recent techniques based on constellations of appearance features (e.g., [5]), which are common in computer vision, are not well suited to handle such amorphous structures. Consequently, with few exceptions (e.g., [11]) medical applications commonly approach this problem by applying classification algorithms that rely on a voxel-by-voxel analysis (e.g., [14], [15], [16], [17]) These approaches, however, are limited in their ability to utilize regional properties, particularly properties related to the shape, boundaries, and texture. ¹ Numbers refer to referenced literature listed at end of specification

### SUMMARY OF THE INVENTION

The present invention introduces a novel multiscale method and apparatus that combines segmentation with classification to detecting abnormal or anatomical tissue or bone structures, and in particular, 3D brain structures. The method is based on a combination of a powerful multiscale segmentation algorithm, Segmentation by Weighted Aggregation (SWA) ([12], [7]), a rich feature vocabulary describing the segments, and a decision tree-based classification of the segments. By combining segmentation and classification, integrative and regional properties are able to be utilized that provide regional statistics of segments, characterize their overall shapes, and localize their boundaries. At the same time, the rich hierarchical decomposition produced by the SWA algorithm allows to a great extent circumventing inaccuracies due to the segmentation process. Even when a lesion is not segmented properly one can generally expect to find some aggregate in the hierarchy that sufficiently overlaps it to allow classification.

The SWA algorithm is adapted to handle 3D multi-channel MRI scans and anisotropic voxel resolutions. These allow the algorithm to handle realistic MRI scans. The bank of features used characterizes each aggregate in terms of intensity, texture, shape, and location. These features were selected in consultation with expert radiologists. All the features are computed as part of the segmentation process, and they are used in turn to further affect the segmentation process. The classification step examines each aggregate and labels it as either lesion or non-lesion. This classification is integrated across scale to determine the voxel classification of the lesions. The utility of the method is demonstrated through experiments on simulated and real MRI data showing detection of MS lesions.

Other and further objects and advantages of the invention will become apparent from the following detailed description taken in conjunction with the drawings.

### BRIEF DESCRIPTION OF THE DRAWINGS

FIG. 1 is an illustration of the irregular pyramid notion of the invention with the image presented as 3 graph levels above one slice from the entire 3D MRI.

FIG. 2 is an illustration of MS-lesion detection showing from left to right: the original data (a), the expert labeling (b), the automatic segmentation (c) and the full range of soft classification (d) overlaid on a FLAIR slice. The different colors in (d), shown as different contrasts, refer to different normalized intensity levels (ranging from blue to red).

FIG. 3 illustrates Multi-channel data showing from left to right T1, PD, T2, ‘ground-truth’ overlaid on the T2 image (red shown as contrast in black and white). Below the main illustrations are magnifications of the lesion area.

FIG. 4 illustrates 3D views of MS lesions detected, showing a comparison of expert labeling with automatic segmentation overlaid on an axial FLAIR slice.

FIG. 5 shows a computer system usable for the invention.

FIG. 6 shows graphically overlap scores between manual and automatic segmentations over 20 brain scans with decreasing levels of difficulty (from set index 1 to 20). Our results compared with seven other algorithms for the task of GM, WM, and CSF Detection.

FIG. 7 shows images with WM and GM identification with (a) representing WM-Ground-Truth; (b) representing WM-Automatic; (c) representing GM-Ground-Truth; and (d) representing GM-Automatic. The upper row presents classification results projected on a 2D T1 slice. The lower row demonstrates a 3D view of the results.

### DETAILED DESCRIPTION OF SPECIFIC EMBODIMENTS OF THE INVENTION

The following description is organized as follows. First, the segmentation procedure is presented; next, the feature extraction method and the classification model in the novel system; next results based on simulated and real MRI data are presented; next the hardware and software used for the method and apparatus and finally a discussion and conclusions.

### Integrated System

First, the system for detecting abnormal brain structures is described. In a training phase of the system, several MR scans along with a delineation of the lesions in these scans are obtained and input into the hardware. The system uses segmentation to provide a complete hierarchical decomposition of the 3D data into regions corresponding to both meaningful anatomical structures and lesions. Each aggregate is equipped with a collection of multiscale features. Finally, a classifier is trained to distinguish between aggregates that correspond to lesions from those that correspond to non-lesions.

Once the classifier is trained, the novel system is ready to proceed to apply the novel method to unlabeled test data. At this stage the system obtains as input an MRI scan of a single brain. It then segments the scan and extracts features to describe the aggregates. Finally, each aggregate is classified as either a lesion or a non-lesion, and the voxel occupancy of the lesions is determined.

One of the features used to describe an aggregate is its location in the brain. To utilize this property, first each scan is brought to a common coordinate system. In the implementation this was achieved using the SPM software package [6], which registers a scan to an atlas composed of subject average of 152 T1-weighted scans.

### Segmentation

The Segmentation by Weighted Aggregation (SWA) algorithm [12], [7]) is used, which is extended to handle 3D multi-channel and anisotropic data. In this section the SWA algorithm is reviewed along with the novel extensions.

### Segmentation Framework

Given a 3D MRI scan, a 6-connected graph G=(V,W) is constructed as follows. Each voxel i is represented by a graph node i, so V={1, 2, . . . , N} where N is the number of voxels. A weight is associated with each pair of neighboring voxels i and j. The weight wᵢⱼ reflects the contrast between the two neighboring voxels i and j

wᵢⱼ=e^{-α|I}^{ᵢ}^{-I}^{ⱼ}^{|}, (1)

where Iᵢ and Iⱼ denote the intensities of the two neighboring voxels, and α is a positive constant. (α=15 in our experiments). We define the saliency of a segment by applying a normalized-cut-like measure as follows. Every segment S⊂V is associated with a state vector u=(u₁, u₂, . . . , uₙ), representing the assignments of voxels to a segment S

$${u}_{i} = \{ \begin{matrix}1 & i ∈ S \\ 0 & i ∉ S\end{matrix}$$

The saliency Γ associated with S is defined by

$$Γ ( S ) = \frac{{u}^{T} Lu}{\frac{1}{2} {u}^{T} Wu} , \qquad ( 2 )$$

that sums the weights along the boundaries of S divided by the internal weights. Segments that yield small values of Γ(S) are considered salient. The matrix W includes the weights wᵢⱼ, and L is the LaPlacian matrix of G. Our objective is to find those partitions characterized by small values of [symbol] . To find the minimal cuts in the graph, we construct a coarse version of this graph. This coarse version is constructed so that we can use salient segments in the coarse graph to predict salient segments in the fine graph using only local calculations. This coarsening process is repeated recursively, constructing a full pyramid of segments (FIG. 11). Each node at a certain scale represents an aggregate of voxels. Each segment S, which is a salient aggregate (i.e., [symbol] is low), emerges as a single node at a certain scale.

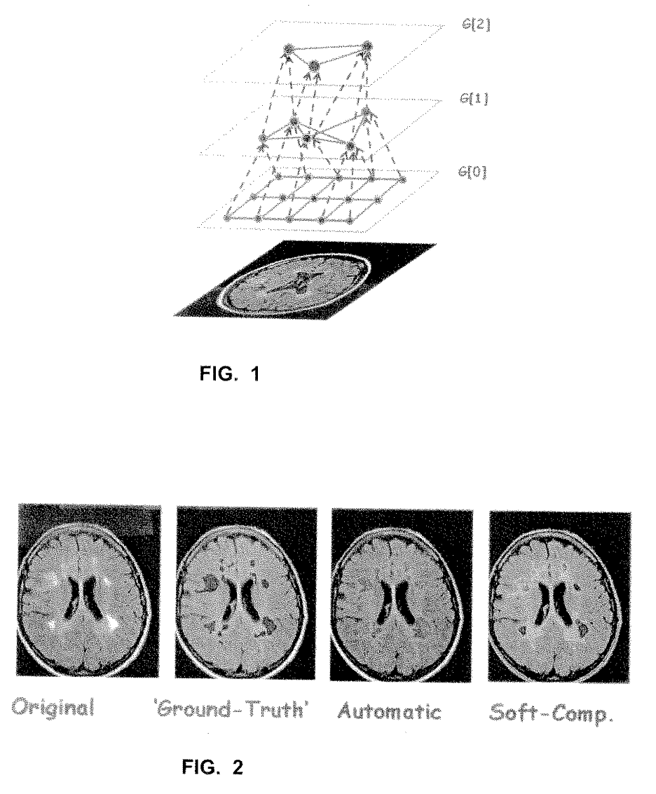

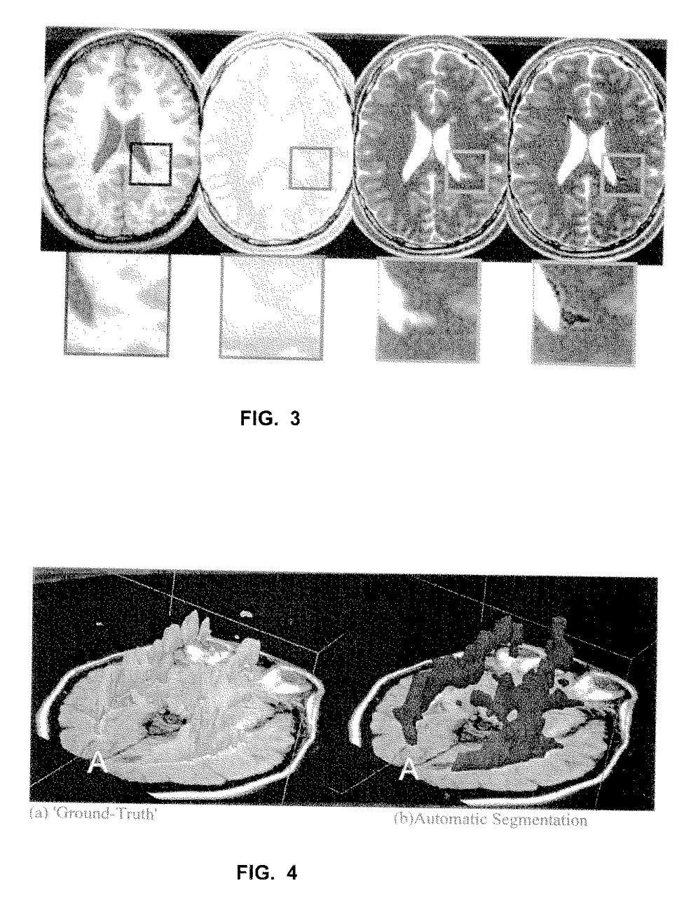

FIG. 1 is an illustration of the irregular pyramid notion. The image presents 3 graph levels above one slice from the entire 3D MRI.

The coarsening procedure proceeds recursively as follows. Starting from the given graph

$${G}^{[ 0 ]} {=}^{def} G ,$$

we create a sequence of graphs G^{[1]} . . . G^{[k]} of decreasing size (FIG. 1).

As in the general AMG setting [1], the construction of a coarse graph from a fine one is divided into three stages: first a subset of the fine nodes is chosen to serve as the seeds of the aggregates (the latter being the nodes of the coarse graph). Then, the rules for interpolation are determined, establishing the fraction of each non-seed node belonging to each aggregate. Finally, the weights of the edges between the coarse nodes are calculated.

Coarse seeds: The construction of the set of seeds C, and its complement denoted by F, is guided by the principle that each F-node should be “strongly coupled” to C. To achieve this objective we start with an empty set C, hence F=V, and sequentially (according to decreasing aggregate size defined herein) transfer nodes from F to C until all the remaining IεF satisfy

$${\sum }_{i ∈ C} {ω}_{ij} \geq β {\sum }_{j ⋃ V} {ω}_{ij}$$

where β is a parameter (in the experiments β=0.2).

The coarse problem: We define for each node

IεF a coarse neighborhood Nᵢ={jεC,ωᵢⱼ>0} Let I(j) be the index in the coarse graph of the node that represents the aggregate around a seed whose index at the fine scale is j. An interpolation matrix P (of size N×n, where n=|C|) is defined by

$${P}_{il ( j )} = \{ \begin{matrix}\frac{{ω}_{ij}}{{\sum }_{k ∈ {N}_{j}} {ω}_{ik}} & for i ∈ F , j ∈ N \\ 1 & for i ∈ C , j = i \\ 0 & otherwise\end{matrix} \qquad ( 3 )$$

This matrix satisfies u≈PU, where u^{[s]}=(u₁^{[s]}, u₂^{[s]}, . . . , u_{N}^{[s]}) is the coarse level state vector. P_{II} represents the likelihood that an aggregate i at a fine level belongs to an aggregate l at a coarser level. Finally, an edge connecting two coarse aggregates p and q is assigned with the weight:

$${ω}_{pq}^{coarse} = {\sum }_{k = l} {P}_{kp} {ω}_{kl} {P}_{lq} \qquad ( 4 )$$

Denoting the scale by a superscript G^{[0]}=(V^{[0]},E^{[0]},W^{[0]}). Note that since=u^{[s-1}]=Pu^{[s]}, the relation Eq. (2) inductively implies that a similar expression approximates r at all levels. However, W^{[s]} is modified to account for aggregative properties. We modify w_{pq}^{[s]} between a pair of aggregates p and q at scale s by multiplying it with an exponentially decreasing function of their aggregative properties distance.

Table 1 summarizes the segmentation algorithm.

TABLE 1
Outline of the 3D segmentation algorithm

```
Initialization: Given a 3D MRI data set construct the 6-connected graph
G^{[0]} = (V^{[0]},E^{[0]},W^{[0]})
Repeated recursive procedure: For s=1, 2. ... Construct G^{[s]} from G^{[s-1]}
    Block selection: Select a representative set of nodes V^{[s]}, such that
V^{[s-1]}\V^{[s]} is strongly connected to V^{[s]}.
    Inter-scale interpolation: Define P=P^{[s-1]} the inter-scale
interpolation matrix (Equation (3)).
    Calculate the coarse graph similarity matrix: W^{[s]} ≈P^{T}W^{[s-1]}P by
weighted aggregation Eq. (4).
    Compute statistic measurements: For each node belongs to V^{[s]}
calculate aggregative properties.
    Update the similarity matrix: Modify W^{[s]} according to aggregative
properties.
```

### Handling Anisotropic Data

Common MRI data is anisotropic, less vertically resolved. The SWA algorithm, however, assumes that the voxels in the fine level are equally spaced. Ignoring this effect may lead to distorted segmentations. To solve this problem we modify the algorithms as follows. During the first few coarsening steps we consider each 2D slice separately in performing seed selection and inter-scale interpolation (steps 1-2 in Table 1) allowing non-zero interpolation weights only between nodes of the same slice. The rest of the steps (steps 3-5 in Table 1) are performed on the full 3D graph, i.e., taking into account inter-slice connections. This procedure is repeated until the inner- and inter-slice distances are approximately equal. Subsequent coarsening steps consider the full 3D graph.

For example, consider data with 5ₘₘ slice thickness versus 1ₘₘ×1ₘₘ in-slice resolution. Every coarsening step of the SWA algorithm typically reduces the number of nodes by a factor of 2.5-3. Consequently, if we apply the algorithm to a 2D slice, the distance between neighboring nodes in a slice grows at every level by a \sqrt{2.5}-\sqrt{3} factor on average, so three coarsening steps are needed to bring the inner- and inter-slice distances to be roughly equal.

### Multi-Channel Segmentation

A major aspect of MR imaging is the large variety of pulse sequences that can be applied. These sequences produce different images for the same tissue, highlighting different properties of the tissue. We incorporate multi-channel data in the algorithm in a fairly straightforward manner. Given a multi-channel scan, each voxel now includes a vector of intensities. The initialization step Eq. (1) is modified to determine the initial weights utilizing intensity information from all m channels as follows:

$${ω}_{ij} = exp - {( \frac{{\sum }_{c = 1}^{m} {α}^{c} [ {( {I}_{i}^{c} - {I}_{j}^{c} )}^{2} ]}{{\sum }_{c = 1}^{m} {α}^{c}} )}^{1 / 2} \qquad ( 5 )$$

where α_{c} are pre-determined constants (α_{T2}=15, α_{PD}=α_{T1}=10) and Iᵢ^{c} is the intensity of voxel i in channel c. In addition, we maintain different sets of aggregative features for every channel (see herein below) and use these properties to modify the edge weights at coarser levels.

### Feature Extraction

Lesions can often be characterized by properties of aggregates that emerge at intermediate scales, and are difficult to extract by any uni-scale procedure. Such properties may include, for instance, intensity homogeneity, principal direction of the lesion, and intensity contrast with respect to neighboring tissues. Voxel-by-voxel analysis is limited in the ability to utilize such scale-dependent properties.

We refer to such properties as aggregative features. The weighted-aggregation scheme provides a recursive mechanism for calculating such properties along with the segmentation process. We use these properties for two purposes. First, we use these aggregative properties to affect the construction of the segmentation pyramid. Second, these properties are available for the classification procedure, see below.

### Aggregative Features

For an aggregate k at scale s we express an aggregative property as a number reflecting the weighted average of some property q emerged at a finer scale r, (r≦s). For example, the average intensity of k is an aggregative property, since it is the average over all intensities measured at the voxels (nodes of scale r=0) that belong to k. More complex aggregative properties can be constructed by combining several properties (e.g., variance below) or by taking averages over aggregative properties of finer scales (e.g., average of variances below). We denote such a property by Qₖ^{[r][s]}, and shorten this to Q^{[r]}: when the context is clear.

In addition to these properties we can define binary aggregative properties, reflecting relations between two aggregates k and l at scale s. Such properties, denoted by Qₖₗ, are useful for describing boundary relations between neighboring tissues, e.g., surface area of boundary between k and l or the contrast between the average intensity of an aggregate k and the average intensity of its neighbors.

The aggregative properties of an aggregate k are in fact averages over its sub-aggregates properties. Such properties can be accumulated from one level of scale to the next with the interpolation weights determining the relative weight of every sub-aggregate. For a detailed description on the accumulation of such properties see [7].

Construction of the classifier based on these features requires consideration of the inter-subject and intra-subject variability; therefore all features were normalized for each brain.

Table 2 lists the features for aggregate k at scale s. The features were selected based on interaction with expert radiologists. However, the effect of each feature in classification is determined by an automatic learning process.

TABLE 2
Aggregative features for an aggregate k

```
S Saliency: Γ (Eq. 2).
Intensity statistics:
  Average intensity: of voxels in aggregate k, denoted Ī^{[0]}.
  Maximum intensity: μₖ^{[2][s]} maximal average intensity of the sub-
aggregates at scale 2.
  Variance of average intensities of scale r: V^{[r]}= Ī^{2[r]}− (Īₖ^{[0]})² where Ī^{2[r]}
denotes the average of (Īₗ^{[0][r]})² for all sub-aggregates l of k at scale r.
  Average of variances: of scale r is denoted v̅^{[r]}where vₖ^{[r][r]} = V^{[0][r]}.
Shape:
  Volume: m^{[0]} is the aggregate volume in voxel units.
  Location: x̅^{[0]}, y̅^{[0]}, z̅^{[0]}.
  Shape moments: The length, width, depth (L^{[0]}, W^{[0]}, D^{[0]}respectively),
and orientation are specified by applying principal component analysis to the
covariance matrix of the aggregate.
  Intensity moments: Averages of products of the intensity and the
coordinates of voxels in aggregate k, denoted I̅x̅^{[0]}, I̅y̅^{[0]}, I̅z̅^{[0]}.
Neighborhood statistics:
Boundary surface area: denoted Bₖₗ · Bₖₗ refers to the surface area of the
common border of aggregates k and l. It is accumulated by weighted
aggregation such that all the weights on the finest graph are set to 1.
Neighborhood Contrast: defined as the difference between the average
intensity of a segment and its neighborhood average intensity, formulated as:
${〈 contrast 〉}_{k} = {I}_{k}^{[ 0 ]} - \frac{{\sum }_{l} {B}_{kl} {I}_{l}^{[ 0 ]}}{{\sum }_{l} {B}_{kl}}$
```

### Classification

Once the MRI scan is segmented and features are computed, so that each aggregate is characterized by a high-dimensional feature vector f (see Table 1), we proceed to the classification stage. A classifier utilizing multiple decision trees [2] is trained using labeled data. Then, given an unlabeled scan the classifier is used to detect the lesions. The classification is described below.

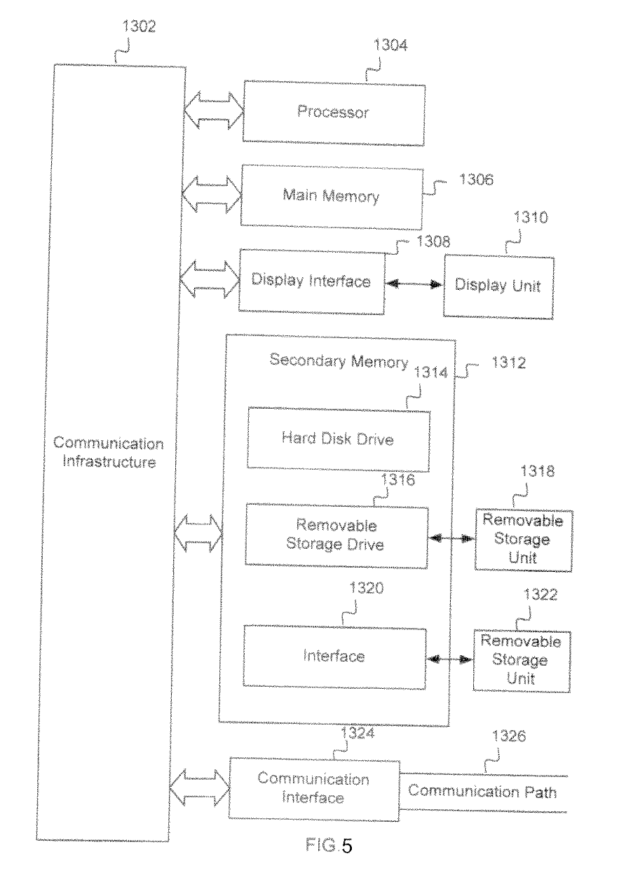

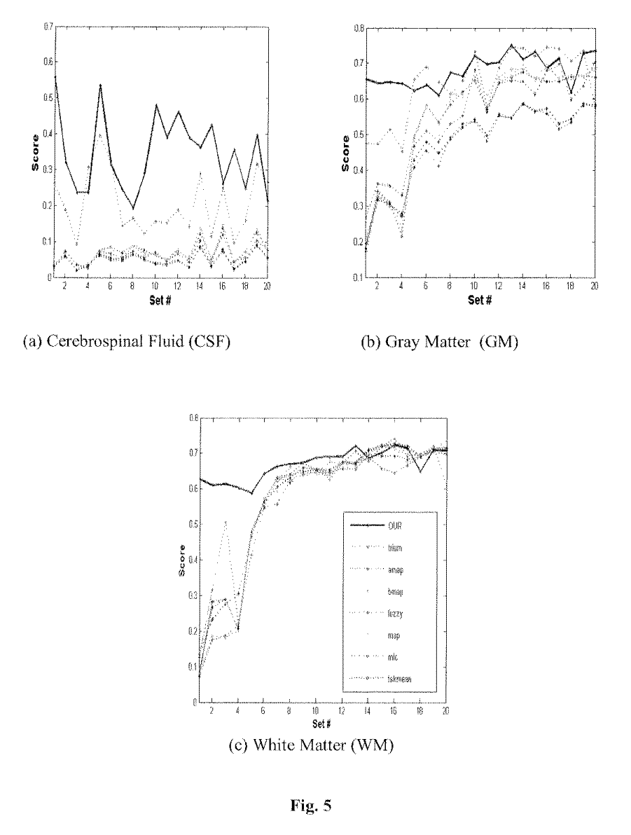

FIG. 5 illustrates MS-lesion detection. Shown from left to right: the original data (a), the expert labeling (b) the automatic segmentation (c) and the full range of soft classification (d) overlaid on a FLAIR slice. The different colors (contrasts in B-W) in (d) refer to different normalized intensity levels (ranging from blue to red).

### Multiple Decision Trees

To construct the decision tree classifier, a learning process is applied using MRI scans with MS lesions delineated by experts. The process obtains two kinds of data. (1) A collection of M candidate segments, Cand={f₁ . . . , f_{M}} each is described by a d-dimensional feature vector (each feature is normalized to have zero mean and unit variance), and (2) a mask indicating the voxels marked as lesions by an expert. Since many of the candidate segments may contain a mixed collection of lesion and non-lesion voxels we label as a lesion a segment in which ≧70% of its voxels were marked by an expert as lesion. This class is denoted by c₁. Further, only those segments that do not contain lesion voxels at all are marked as non-lesions. This class is denoted by c₂. The rest of the segments are ignored at the training stage.

Next, the training data is used to construct multiple decision trees. A subset of the segments are randomly selected and used to construct a tree from the root downwards. At the root node all the labeled segments are considered and are repeatedly split into two subsets. At each tree node a Fisher Linear Discriminant (FLD) [4] is applied to the data determining the optimal separation direction and threshold s that leads to a maximal impurity decrease. This training procedure results in a forest of K decision trees T₁, . . . , T_{K} each trained with a random selection of segments.

During the testing phase an unseen MRI scan is obtained. After segmentation and feature extraction we classify every segment f by each of the K trees. Each tree T_{q} then determines a probability measure P_{T}_{_{q}}(fεcⱼ) according to the distribution of training patterns in the terminal leaf node reached. These measures are integrated by taking their mean

$$\frac{1}{k} {\sum }_{q = 1}^{K} ( f ∈ {c}_{j} )$$

Finally, a test segment is assigned with the label cⱼ that maximizes this mean.

### Classification of Voxels

The classification process is applied to three segmentation scales, corresponding to small, intermediate, and large segments respectively. For each of these scales there is constructed a separate forest consisting of K=100 trees, trained with a random selection of Nₛ≦3000 patterns. The candidate segments for classification may overlap, so that a voxel may belong to more than one segment. To measure the total lesion load (TLL) it is necessary to generate a result in terms of voxels.

The classifier labels the candidate segments as lesion or non-lesion with some probability. All candidates are projected onto the data voxels using the interpolation matrix. Therefore, the interpolation matrix (eq. (3)) determines an association weight for each voxel and candidate. A voxel belongs to a candidate if the corresponding association weight ≧0.5. The maximum probability over all candidates to which the voxel belongs, determines the probability of the voxel to be a lesion. Further, there is employed both a hard and a soft classification of voxels. In the hard classification a voxel is classified as a lesion if its probability to be a lesion ≧0.5. However, since the ‘ground truth’ of the lesions may vary among different experts it might be helpful to provide a soft classification of the candidates rather than just a binary result. To create the soft classification, each 2D slice is first normalized by the average intensity of the intra-cranial cavity (ICC) in the related 2D slice. Then, by selecting from the hard assignment only voxels with normalized values above a certain threshold (1.75, 1.3 for multi-channel, FLAIR data respectively) one can determine a specific soft assignment, which is denoted as automatic classification result.

### Application to Multiple Sclerosis (MS)

Below is presented validation results of employing the novel integrated system to both simulated and real MR data.

Before applying classification candidates are eliminated whose properties differ considerably from those expected from a lesion, Those include very non-salient regions (saliency >7), very large regions (volume >5000 voxels), regions located very close to the mid-sagittal plane (|x|<6), and very dark regions (intensity <0.75 and contrast to neighborhood <−0.25, where both are divided by the average ICC intensity). In addition we eliminate aggregates that overlap with anatomical structures where as a rule lesions do not develop. Those include the eyes and the cerebro-spinal fluid (CSF). To identify those structures we currently mark the segments corresponding to those structures manually. These structures can be identified automatically by considering an atlas, as will be described further on in this document. We further use the automatic skull stripping utility (Brain Extraction Tool [13]) to identify the brain region and eliminate segments that exceed beyond these regions.

The segmentation complexity is linear in the number of voxels. The complexity for generating a tree classifier is O(d²Nₛ log(Nₛ)+d³Nₛ+dNₛ(log(Nₛ))²) and dominated by O(dNₛ(log(Nₛ))²), where Nₛ is the number of training patterns and d is the number of features. The testing complexity is O(d log(Nₛ)) per one test sample.

### MR Simulator Data

First are presented results of the novel integrated system on the Simulated Brain Database (SBD) provided by the McConnell Brain Imaging Center ([3]). Currently, the SBD contains three simulated models of brains (phantoms) with ‘mild’, ‘moderate’, and ‘severe’ levels of MS lesions. The invention was tested on the three MS phantoms each including T1, T2 and PD images (see FIG. 4) using the default parameters (“normal” [17]): voxel size 1ₘₘ³, SD of noise 3% and intensity non-uniformity (INU) 20%.

FIG. 4 shows multi-channel data. From left to right T1, PD, T2, ‘ground-truth’ overlaid on the T2 image (red, contrast in B-W). Below these images are magnifications of the corresponding lesion areas.

The multi-channel experiment was performed on the three channels for 30 slices, which contain 80% of the lesion load. The MS lesions presented in these models are not symmetric between the left and right lobes. Training was performed on the right half of all three brain models and testing on the left half of the brains, where the midpoint was defined by the midsagittal plane. The detection rate measures the percentage of correct classifications of candidate segments in the test set (see definitions in sec. 0). The classification forests of the segments test set on all scales obtained a detection rate of (1, 0.99, 0.99) for the lesion class (c₁), non-lesion class (c₂) and total candidate set, respectively.

Denote (S) as a set of voxels detected as lesions by the system and (R) as the set of voxels labeled as MS lesions in the ‘ground truth’ reference. n_{S}, n_{R} denote the number of connected components (lesions) in S and R correspondingly.

Table 3 lists classification measures which are commonly used (e.g., [9], [14], [17]). These measures are presented in Table 4 and Table 6.

Table 4 shows results obtained after overlaying the candidates from all scales detected as MS by the forest classifiers.

TABLE 3
Classification measures

#Hits: n_{S}/n_{R}
Overlap (|S∩R|)/|R| Number of voxels in the intersection divided by the
number of voxels in R
FP rate (|S∩ R̅|)/|R|
Disconnected FP (DFP) rate: Number of voxels in extra volume which
are disconnected to any ground-truth lesion divided by |R|.
Similarity measure: κ = 2*(|S∩R|)/(S + R) where a value ≧0.7 is
considered as an excellent agreement [17].

TABLE 4
Phantom classification measures for each model separately,
summarizing with the mean and S.D results on all three models.

| | #Hit | Overlap | FP | DFP | k |
|---|---|---|---|---|---|
| Mild | 0.74 | 0.87 | 1.1 | 0 | 0.67 |
| Moderate | 0.85 | 0.98 | 0.83 | 0.04 | 0.86 |
| Severe | 0.93 | 0.98 | 1.02 | 0.01 | 0.87 |
| Mean | 0.84 | 0.94 | 0.99 | 0.02 | 0.8 |
| SD | 0.1 | 0.06 | 0.14 | 0.02 | 0.11 |

To compare the results with other methods, there was applied the automatic classification of the detected area using one specified threshold for all subjects. We obtained an average of κ=0.80±0.11 (mean±S.D) on all three phantoms. In comparison, the authors in [17] tested their pipeline on the simulated data with varying levels of noise and INU. Their best classification accuracy reported for the single condition with the same parameters used in our tests was 0.81.

### Real MR Data

To further evaluate our approach on clinical images, which reflect the full range of pathological variability, the novel algorithm was tested on real MR data [10]. This study consists of 16 subjects for which MS lesions were manually traced by a human expert. In this case, single channel FLAIR images were used, which are known for their high sensitivity to lesions, offering a diagnostic capability beyond other sequences. The voxel size used is 0.97ₘₘ×0.97ₘₘ or 0.86ₘₘ×0.86ₘₘ (for 6 and 10 subjects respectively), with slice thickness 5ₘₘ (24 slices). The data was divided as follows: set A includes examination of 12 patients and set B includes examinations of four additional patients which had a monthly follow up, so that four time points were available for each patient.

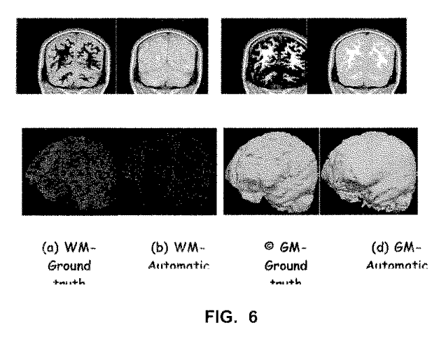

FIG. 6 shows the 3D view of MS lesions detected. Comparison of expert labeling with automatic segmentation overlaid on an axial FLAIR slice.

### Validation Results

Throughout the classification stage ten experiments were conducted. In each experiment, nine patients from set A were randomly selected for training. The test set consists of the remaining patients of set A and all patients of set B. In each one of the ten experiments three multiscale forests were generated.

Table 5 presents average detection rates for each scale over ten experiments.

TABLE 5
Detection rates obtained on real data
over ten randomized experiments

| Scale | Lesion | Non-Lesion | Total |
|---|---|---|---|
| Small | 0.92 ± 0.01 | 0.97 ± 0.01 | 0.97 ± 0.01 |
| Interm | 0.96 ± 0.01 | 0.98 ± 0.005 | 0.98 ± 0.004 |
| Large | 0.98 + 0.01 | 0.98 + 0.004 | 0.98 ± 0.004 |

Table 6 lists the average classification measures over the ten experiments for test sets A and B. We also assessed the significance of correlation coefficient between the ILL volume detected by expert and automatic segmentation for each set. The two upper rows in Table 6 demonstrate the results obtained for superior slices (above the eyeballs) where on average 0.88±0.05 of lesion volume occurs. The results in two lower rows were obtained on all slices. They are slightly lower due to the many artifacts in FLAIR data found in inferior slices.

TABLE 6
Classification measures for real MR sets, averaged over ten experiments

| | | | | | | | corr. |
|---|---|---|---|---|---|---|---|
| Slices | Test set | #Hit | Overlap | FP | DFP | K | significance |
| Superior | A: | 0.85 ± 0.1 | 0.91 ± 0.05 | 1.53 ± 0.72 | 0.22 ± 0.21 | 0.64 ± 0.07 | p < 0.005 |
| | B: | 0.83 ± 0.08 | 0.93 ± 0.02 | 1.36 ± 0.33 | 0.12 ± 0.12 | 0.66 ± 0.05 | p < 0.005 |
| All | A: | 0.82 ± 0.09 | 0.89 ± 0.05 | 1.67 ± 0.71 | 0.36 ± 0.33 | 0.6 ± 0.07 | p < 0.005 |
| | B: | 0.80 ± 0.08 | 0.91 ± 0.02 | 1.37 ± 0.39 | 0.18 ± 0.16 | 0.62 ± 0.06 | p < 0.005 |

Comparing to results reported in literature demonstrates the difficulty of the MS detection problem and reveals the high accuracy obtained by the invention. Correspondence results reported in [14] on multi-channel data were κ=0.45, 0.51, for 5ₘₘ,3ₘₘ slice thickness respectively. In [17] the average κ=0.6±0.07, whereas the κ similarity between pairs of 7 experts ranges from 0.51 to 0.67.

Over superior slices, our average was κ≧0.64. Results for all slices are comparable to the state-of-the-art (κ≧0.6). The extra volume exhibited by high FP measure may require further exploration. In our experiments, the main extra volume usually surrounds the lesion volume and the DFP is significantly small compared to the FP. Preliminary assessment of our results indicates that this extra volume is somewhat related to other WM classes (e.g. ‘dirty-appearing’ WM DAWM [8]). Moreover, the delineation of lesion volume varies significantly between different experts, i.e., volume ratios reported in literature may exceed 1.5 and even approach 3 ([14], [16], [17]). Therefore, it was concluded that the FP measure is in the range of the inter-rater variability.

### Volume Precision Over Time

Four sets of images that were acquired over four months (set B) were analyzed. Generally tests for robustness of reproducibility analysis should be performed on data rescanned repeatedly from the same brain. Here, since the interval between two scans was not short, the volume may also vary due to actual changes in patient pathology. However we performed a serial analysis and computed the ratio of volume difference between our detection and the ground-truth divided by the ground truth volume. The average results over time for the four subjects were (0.1±0.05, 0.06±0.06, 0.08±0.04, 0.39±0.11), respectively. For the last subject significantly worse results were obtained probably due to the considerably smaller TLL relative to the other three subjects.

### Apparatus

The present invention (i.e., system or apparatus described in detail in this description of specific embodiments) can be implemented using a computer system as generally depicted in FIG. 5 using hardware 1302-1326 as labeled, software or a combination thereof and may be implemented in one or more computer systems or other processing systems, and the capability would be within the skill of one ordinarily skilled in the art of programming of computers from the teachings and detailed disclosure provided in the foregoing description of the apparatus and the process. The computer system of the invention represents any single or multi-processor computer, and in conjunction therewith, single-threaded and multi-threaded applications can be used. Unified or distributed memory systems can be used. In one example, the system and method of the present invention is implemented in a multi-platform (platform independent) programming language such as Java, programming language/structured query language (PL/SQL), hyper-text mark-up language (HTML), practical extraction report language (PERL), Flash programming language, common gateway interface/structured query language (CGI/SQL) or the like and can be implemented in any programming language and browser, developed now or in the future, as would be apparent to a person skilled in the relevant art(s) given this description.

In another example, the system and method of the present invention, may be implemented using a high-level programming language (e.g., C++) and applications written for the Microsoft Windows NT or SUN OS environments. It will be apparent to persons skilled in the relevant art(s) how to implement the invention in alternative embodiments from the teachings herein.

The Computer system of the invention includes one or more processors and can execute software implementing the routines described above. Various software embodiments are described in terms of this exemplary computer system. After reading this description, it will become apparent to a person skilled in the relevant art how to implement the invention using other computer systems and/or computer architectures.

The Computer system can include a display interface that forwards graphics, text, and other data from the communication infrastructure (or from a frame buffer not shown) for display on the display unit included as part of the system.

The Computer system also includes a main memory, preferably random access memory (RAM), and can also include a secondary memory. The secondary memory can include, for example, a hard disk drive and/or a removable storage drive, representing a floppy disk drive, a magnetic tape drive, an optical disk drive, etc. The removable storage drive can read from and/or write to a removable storage unit in a well-known manner.

In alternative embodiments, a secondary memory may include other similar means for allowing computer programs or other instructions to be loaded into computer system. Such means can include, for example, a removable storage unit and an interface. Examples can include a program cartridge and cartridge interface (such as that found in video game console devices), a removable memory chip (such as an EPROM, or PROM) and associated socket, and other removable storage units and interfaces that allow software and data to be transferred from the removable storage unit to computer system.

The Computer system can also include a communications interface that allows software and data to be transferred between computer system and external devices via a communications path. Examples of communications interface can include a modem, a network interface (such as Ethernet card), a communications port, interfaces described above, etc. Software and data transferred via a communications interface are in the form of signals that can be electronic, electromagnetic, optical or other signals capable of being received by communications interface, via a communications path. Note that a communications interface provides a means by which computer system can interface to a network such as the Internet.

The present invention can be implemented using software running (that is, executing) in an environment similar to that described above with respect to FIG. 5. In this document, the term “computer program product” is used to generally refer to removable storage unit, a hard disk installed in hard disk drive, or carrier wave carrying software over a communication path (wireless link or cable) to a communication interface. A computer useable medium can include magnetic media, optical media, or other recordable media, or media that transmits a carrier wave or other signal. These computer program products are means for providing software to the computer system.

Computer programs (also called computer control logic) are stored in main memory and/or secondary memory. Computer programs can also be received via a communications interface. Such computer programs, when executed, enable the computer system to perform the features of the present invention as discussed herein. In particular, the computer programs, when executed, enable the processor to perform features of the present invention. Accordingly, such computer programs represent controllers of the computer system.

The present invention can be implemented as control logic in software, firmware, hardware or any combination thereof. In an embodiment where the invention is implemented using software, the software may be stored in a computer program product and loaded into computer system using a removable storage drive, hard disk drive, or interface. Alternatively, the computer program product may be downloaded to computer system over a communications path. The control logic (software), when executed by the one or more processors, causes the processor(s) to perform functions of the invention as described herein.

### Non-Limiting Software and Hardware Examples

Embodiments of the invention can be implemented as a program product for use with a computer system such as, for example, the cluster computing environment shown in FIG. 1 and described herein. The program(s) of the program product defines functions of the embodiments (including the methods described herein) and can be contained on a variety of signal-bearing medium. Illustrative signal-bearing medium include, but are not limited to: (i) information permanently stored on non-writable storage medium (e.g., read-only memory devices within a computer such as CD-ROM disk readable by a CD-ROM drive); (ii) alterable information stored on writable storage medium (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the present invention, whether implemented as part of an operating system or a specific application, component, program, module, object or sequence of instructions may be referred to herein as a “program.” The computer program typically is comprised of a multitude of instructions that will be translated by the native computer into a machine-readable format and hence executable instructions. Also, programs are comprised of variables and data structures that either reside locally to the program or are found in memory or on storage devices. In addition, various programs described herein may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It is also clear that given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.) It should be appreciated that the invention is not limited to the specific organization and allocation or program functionality described herein.

The present invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

Each computer system may include, inter alia, one or more computers and at least a signal bearing medium allowing a computer to read data, instructions, messages or message packets, and other signal bearing information from the signal bearing medium. The signal bearing medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the signal bearing medium may comprise signal bearing information in a transitory state medium such as a network link and/or a network interface, including a wired network or a wireless network, that allow a computer to read such signal bearing information.

In another embodiment, the invention is implemented primarily in firmware and/or hardware using, for example, hardware components such as application specific integrated circuits (ASICs). Implementation of a hardware state machine so as to perform the functions described herein will be apparent to persons skilled in the relevant art(s) from the teachings herein.

### Discussion

Presented is a novel multiscale method and apparatus that combines segmentation with classification for detecting abnormal 3D brain structures. The focus was on analyzing 3D MRI brain data containing brain scans of multiple sclerosis patients. The method is based on a combination of a powerful multiscale segmentation algorithm, a rich feature vocabulary describing the segments, and a decision tree-based classification of the segments. By combining segmentation and classification it was possible to utilize integrative, regional properties that provide regional statistics of segments, characterize their overall shapes, and localize their boundaries.

The multiscale segmentation algorithm was adapted to handle 3D multi-channel MRI scans and anisotropic voxel resolutions. The rich set of features employed was selected in consultation with expert radiologists. All the features are computed as part of the segmentation process, and they are used in turn to further affect the segmentation process. The classification step examines each aggregate and labels it as either lesion or non-lesion. This classification is integrated across scale to determine the voxel occupancy of the lesions. We have demonstrated the utility of our method through experiments on simulated and real MRI data, including several modalities (T1, T2, PD and FLAIR). Comparison of the results to other automated segmentation methods applied to Multiple Sclerosis shows the high accuracy rates obtained by the system.

The approach is flexible with no restrictions on the MRI scan protocol, resolution, or orientation. Unlike common approaches the novel method does not require a full brain tissue classification into white matter (WM), gray matter (GM), and cerebro-spinal fluid (CSF), and it is not limited to finding the lesions in the WM only, risking the omission of sub-cortical lesions. Furthermore, the novel learning process requires only a few training examples, as shown specifically in the experiments.

We believe that the inventive method and apparatus can further be improved by better exploiting the rich information produced by the segmentation procedure. Other features that can characterize lesions, as well as features that can characterize dirty appearing white matter (DAWM) can be incorporated. Also of importance is to incorporate prior knowledge of anatomic structures into the framework using a brain atlas. Finally, the novel method and apparatus can be applied to other tasks and modalities in medical imaging.

There follows now a description of an atlas guided Identification of brain structures by combining 3D segmentation and SVM classification.

The following presents a novel automatic approach (method and apparatus) for the identification of anatomical brain structures in magnetic resonance images (MRI). The method combines a fast multiscale multi-channel three dimensional (3D) segmentation algorithm providing a rich feature vocabulary together with a support vector machine (SVM) based classifier. The segmentation produces a full hierarchy of segments, expressed by an irregular pyramid with only linear time complexity. The pyramid provides a rich, adaptive representation of the image, enabling detection of various anatomical structures at different scales. A key aspect of the invention is the thorough set of multiscale measures employed throughout the segmentation process which are also provided at its end for clinical analysis. These features include in particular the prior probability knowledge of anatomic structures due to the use of an MRI probabilistic atlas. An SVM classifier is trained based on this set of features to identify the brain structures. The invention was validated using a gold standard real brain MRI data set. Comparison of the results with existing algorithms displays the promise of the invention.

Accurate classification of magnetic resonance images (MRI) is essential in many neuroimaging applications. Quantitative analysis of anatomical brain tissue, such as, white matter (WM), gray matter (GM) and cerebrospinal fluid (CSF) is important for clinical diagnosis, therapy of neurological diseases and for visualization and analysis ([18], [19], [20]). However, automatic segmentation of MRI is difficult due to artifacts such as partial volume effect (PVE), intensity non-uniformity (INU) and motion. The INU artifact also referred to as inhomogeneity or shading artifact causes spatial inter-scan variation in the pixel intensity distribution over the same tissue classes. It depends on several factors but is predominantly caused by the scanner magnetic field. Numerous approaches have been developed for Brain MRI segmentation (see surveys [18], [21], [22], [23]). Low-level classification algorithms (which are compared in the following) typically involve common unsupervised algorithms including k-means and fuzzy c-means ([19],[21]). Yet, low level techniques that exploit only local information for each voxel and do not incorporate global shape and boundary constraints are limited in dealing with the difficulties in fully automatic segmentation of brain MRI. Deformable models have also been proposed in [24] to find coupled surfaces representing the interior and exterior boundary of the cerebral cortex. These techniques benefit from consideration of global prior knowledge about expected shape yet their limitations come from dependence on initialization and from the computation time required for 3D segmentation.

Statistical approaches, which classify voxels according to probabilities based on the intensity distribution of the data, have been widely used [25]. These approaches typically model the intensity distribution of brain tissues by a Gaussian mixture model. Given the distribution, the optimal segmentation can be estimated by a maximum a posteriori (MAP), or a maximum likelihood (ML) formulation ([19],[20]). The expectation maximization (EM) is a popular algorithm for solving the estimation problem. It has been applied to simultaneously perform brain segmentation and estimate the INU correction [26]. The EM framework has been extended to account for spatial considerations by including a Markov Random Field [27] and by utilizing a brain atlas [28]. This paper introduces a fully automatic method to identify brain structures in MRI, utilizing the 3D segmentation framework presented in [29], which extends the algorithm presented in ([30],[31]) to handle 3D multi-channel anisotropic MRI data. The inventive work combines the fast multiscale segmentation algorithm with a support vector machine (SVM) classifier based on a novel set of features. Prior knowledge of anatomic structures is incorporated using an MRI brain atlas. In addition to these priors a set of regional features are computed for each aggregate, which includes intensity, texture, and shape features, accumulated during the aggregation process. Unlike existing studies the invention does not involve explicit correction of magnetic field inhomogeneities. The invention is validated by applying the inventive method to a standard data base with varying bias field and compare results to existing algorithms.

The following description is organized as follows: a description of the segmentation, feature extraction and classification process. Comparative experimental results for automatic detection of the major brain anatomical tissues are shown below.

### Segmentation

The method begins with utilizing the segmentation algorithm presented in [29]. This algorithm has extended the 2D segmentation algorithm developed for natural images ([30], [31]) to apply it to 3D multi-channel anisotropic MRI data. The segmentation scheme is described briefly below (for more details see [29], [30], [31]), incorporated by reference herein. The method, which is derived from algebraic multigrid (AMG) [32], starts by assembling together adjacent voxels into small aggregates based on intensity similarity, each voxel being allowed to belong to several aggregates with different association weights. These aggregates are then similarly assembled into larger aggregates, then still larger aggregates, etc. The affiliations between aggregates are based on tunable statistical measures, which are called features. Features obtained for small aggregates at a fine level affect the aggregation formation of larger aggregates at coarser levels, according to feature resemblance. In this multiscale Segmentation by Weighted Aggregation (SWA), a pyramid (hierarchy) of aggregates is constructed from fine (bottom) to coarse (top), such that each aggregate at a finer level may be associated to several larger aggregates at a subsequent coarser scale, with different weights. This soft weighted aggregation allows the algorithm to avoid pre-mature local decisions and to detect segments based on a global saliency measure. The algorithm is very fast, since only its initial stage operates at the level of individual voxels. It collects statistics of filter responses, identifies regions of coherent textures, quantifies the shape of segments, their boundaries and their density variability at all scales, etc., allowing the emergence of image segments according to any desired aggregation and saliency criteria. Moreover, each segment emerges from the aggregation process equipped with a list of accumulated numerical descriptors, its features, which can then be used for classification and diagnosis processes.

### Multi-Channel and 3D Anisotropy

A major aspect of MRI is the wide variety of pulse sequences (modalities) available for producing different images. Each modality gives rise to a different image that may highlight different type of tissues. In the present inventive work, segmentation was applied to a single T1 channel. However, applying segmentation (and likewise classification) simultaneously to images obtained by several channels can lead to superior results that usually cannot be achieved by considering just one channel. Another important aspect is the anisotropic nature of most clinical MRI data (with lower vertical resolution) which if not taken into account may lead to inaccurate analysis of the data. Relying on the flexibility of the segmentation framework, the inventive method applied a 3D multi-channel segmentation algorithm that can process several modalities simultaneously, and handle both isotropic data as well as anisotropic data.

### Feature Extraction

The segmentation process computes statistical aggregative features throughout the pyramid construction. These features, which affect the formation of aggregates, are also available for the classification of anatomical structures at the end of the process. The development of the set of features is guided by interaction with expert radiologists, and the quantitative effects of the various features are determined by the automatic learning process described below. It can be shown that these properties can be calculated recursively (see [29], [31] for notations). In this work, the set of features was expanded to include information about the expected location of the major tissue types. The prior probability knowledge of anatomic structures was incorporated using an MRI probabilistic atlas. Employed were the International Consortium for brain mapping (ICBM) probability maps which represent the likelihood of finding GM, WM and CSF at a specified position for a subject that has been aligned to the atlas space. The ICBM452 atlas and brain data sets are brought into spatial correspondence using the Statistical Parametric Mapping (SPM) registration software [33] so that for every aggregate we can compute its average probability to belong to any of the three tissue categories. Construction of the classifier based on these features requires consideration of the inter-subject and intra-subject variability; therefore all features were normalized for each brain. Table 7 presents a partial list of the features for aggregate k at scale s used in the inventive work.

TABLE 7
Aggregative features

Prior anatomical knowledge:
Average probabilities: denoted P̅_̅{̅W̅M̅}̅, P̅_̅{̅G̅M̅}̅, P̅_̅{̅C̅S̅F̅}̅ which represent the average
likelihood of finding WM, GM, and CSF in k respectively.
Intensity statistics:
Average intensity: of voxels in k, denoted 1̅.̅
Maximum intensity: maximal average intensity of sub-aggregates at scale 2.
Variance of average intensities: of sub-aggregates of k at scale r.
Intensity moments: averages of products of the intensity and the coordinates
of voxels in k, denoted I̅x̅^{[0]}, I̅y̅^{[0]}, I̅z̅^{[0]}.
Shape:
Location: averaging the locations of the voxels in k, denoted x̅^{[0]}, y̅^{[0]}, z̅^{[0]},
all the brains were spatially normalized to the same stereotaxic space
using the SPM [33].
Shape moments: the length, width and depth (L, W, D respectively)
calculated by applying principal component analysis to the covariance
matrix of the aggregate.
Neighborhood statistics:
Boundary surface area: denoted Bₖₗ, refers to the surface area of the common
border of aggregates k and l.
$neighborhood average intensity \text{:} of aggregate k defined as \frac{{\sum }_{l} {B}_{kl} {I}_{l}^{[ 0 ]}}{{\sum }_{l} {B}_{kl}} ,$
where in the denominator, for the summation l is not equal to k.

Support Vector Machine (SVM) Classification

A candidate set of segments was extracted from the intermediate level of the pyramid (scales 5, 6 from all 13 scales) which correspond to brain tissue regions. To construct the classifier, “ground-truth” expert segmentation was utilized, which is provided along with the real clinical brain MRI data. Generally, it was assumed (1) having a training sample of M candidate segments, Cand={f₁ . . . f_{M}} each is described by a d-dimensional feature vector (we normalize each of the features to have zero mean and unit variance), and (2) a mask indicating the voxels marked by an expert as GM, WM, CSF and background (BG). Since many of the candidate segments may contain a mixed collection of the categories, the labeling category is determined based on the category marked by the maximum number of voxels associated with the segment.

TABLE 8
Average Classification Measures.

| Clas- | | | | |
|---|---|---|---|---|
| ses | Overlap | FP | K | J |
| WM: | 0:80 ± 0:04 | 0:19 ± 0:05 | 0:80 ± 0:04 | 0:67 ± 0:03 |
| GM: | 0:86 ± 0:04 | 0:26 ± 0:00 | 0:81 ± 0:04 | 0:68 ± 0:03 |
| CSF: | 0:43 ± 0:12 | 0:25 ± 0:20 | 0:51 ± 0:11 | 0:35 ± 0:12 |
| BG: | 0:987 ± 0:005 | 0:003 ± 0:002 | 0:985 ± 0:004 | 0:992 ± 0:002 |

The table 8 lists the mean (±S.D) classification measures obtained on all 20 subjects for the four different classes.

Twenty normal MR brain data sets and their manual segmentations were provided by the Center for Morphometric Analysis at Massachusetts General Hospital and are available at “http://www.cma.mgh.harvard.edu/ibsr/”. The sets are sorted based on their difficulty level. The sets were separated to “odd” and “even” indexes. The classifier was trained on the odd sets and tested on the even sets and vice versa, so that both the training and the testing consist of ten sets including the entire range of difficulty. The training data was used to construct an SVM-based classifier. The results presented here were obtained by using a radial basis function RBF kernel (K(x; y)=eᵢ^{o}jxᵢyj2). A detailed description of SVMs can be found in [34].

Following the learning phase, in the testing phase an unseen MRI scan is obtained. After segmentation and feature extraction we apply the SVM classifier to every candidate segment in the test set and finally assign a category-label to each candidate. All candidates segments are projected onto the data voxels using the segmentation interpolation matrix (see details in [12]). The maximum association weight of the voxel determines the segment to which the voxel belongs, which leads to an assignment of a class label to each voxel.

### Results

The integrated approach was tested on 20 coronal T1-weighted real MRI data set of normal subjects with GM, WM and CSF expert segmentations provided by the Internet Brain Segmentation Repository (IBSR), after they have been positionally normalized. The brain scans used to generate these results were chosen because they have been used in published volumetric studies in the past and because they have various levels of difficulty. This allows the assessment of the methods performance under varying conditions of signal to noise ratio, INU, PVE, shape complexity, etc. The inventive method was tested using 45 central coronal slices which contain 0:94±0:02 of the brain voxels including the cerebellum and brain stem.

The results presented were obtained by overlaying the candidate segments of the brain set tested according to their labeling category by the SVM classifier. The validation scores presented are based on the common measures for spatial overlap (e.g., [23], [36]). Denote by (S) the set of voxels automatically detected as a specific class and (R) the set of voxels labeled as the same class in the ‘ground truth’ reference. The classification measures used in Table 8 and 9 are defined as follows:
Overlap (|S∩R|)/|R|
FP rate (|S∩ R̅|)/|R|
K Statistics (Dice coefficient): κ=2*(|S∩R|)/(S+R)
Jaccard Similarity J: J=|S∩R|/|S∪R|

TABLE 9
Average J-scores for various segmentation methods on 20 brains.

| Method | WM | GM | CSF |
|---|---|---|---|
| Manual(4 brains averaged over 2 experts) | 0.876 | 0.832 | — |
| Our Method | 0.669 | 0.680 | 0.346 |
| Pham and Prince [25] | 0.7 | 0.6 | — |
| Shattuck et. al. [20] | 0.595 | 0.664 | — |
| Zeng et al. [24] | — | 0.657 | — |
| Burkhardt et. Al. [37] (trium) | 0.578 | 0.644 | 0.206 |
| Adaptive MAP (amap) [19] | 0.567 | 0.564 | 0.069 |
| Biased MAP (bmap) | 0.562 | 0.558 | 0.071 |
| Fuzzy c-means (fuzzy) [19] | 0.567 | 0.473 | 0.048 |
| Maximum Aposteriori Probability (map) | 0.554 | 0.550 | 0.071 |
| [19] | | | |
| Maximum-Likelihood (mlc) [19] | 0.551 | 0.535 | 0.062 |
| Tree-structure k-means (tskmeans) [19] | 0.571 | 0.477 | 0.049 |

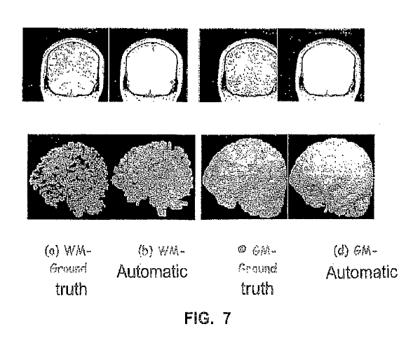

Table 9 and FIG. 6 display a quantitative comparison of invention with ten other algorithms. Six of them are provided with the data [19]. We also included in Table 9 four additional studies which report the average results for part of the tasks ([20], [24], [25], [35]). The comparison is based on the J metric score provided in this work. The average scores for all classes were comparative or superior to previously reported results, where we obtained a significance difference to other algorithms (for the GM and WM p≦0:005). The results are especially high on the most difficult cases (i.e. sets 1-5 see FIG. 6). Moreover, the other metrics presented in Table 8 show high detection rates for all categories identified. FIG. 76 demonstrates the WM and GM segmentations produced by the method in a 2D and 3D view respectively. More particularly, FIG. 6 shows graphically overlap scores between manual and automatic segmentations over 20 brain scans with decreasing levels of difficulty (from set index 1 to 20). In FIG. 6 (a) is shown the results for Cerebrospinal Fluid (CSF); in FIG. 6 (b) is shown the results for Gray Matter (GM); and in FIG. 6 (c) is shown the results for White Matter (WM). The results are compared with seven other algorithms for the task of GM, WM, and CSF Detection. FIG. 7 shows graphically WM and GM identification with FIG. 7 (a) showing WM-Ground-Truth; FIG. 7 (b) showing WM-Automatic; FIG. 7 (c) showing GM-Ground-Truth; and FIG. 7 (d) showing GM-Automatic. The upper row in the figures presents classification results projected on a 2D T1 slice. The lower row of the figures demonstrates a 3D view of the results.

### Discussion

MRI is considered the ideal method for brain imaging. The 3D data and the large number of possible protocols enable identification of anatomical structures, as well as, abnormal brain structures. In this work we focus on segmenting normal brains into three tissues WM, GM and CSF. The segmentation pyramid provides a rich, adaptive representation of the image, enabling detection of various anatomical structures at different scales. A key aspect of the invention is the comprehensive set of multiscale measurements applied throughout the segmentation process. These quantitative measures, which take into account the atlas information, can further be used for clinical investigation. For classification we apply automatic learning procedure based on an SVM algorithm using data pre-labeled by experts. Our approach is unique since it combines a rich and tunable set of features, emerging from statistical measurements at all scales. Our competitive results, obtained using a standard SVM classifier, demonstrate the high potential of such features.

The algorithm was evaluated on real 3D MRI brain scans, demonstrating its ability to detect anatomical brain structures. It requires no restrictions from the MRI scan protocols and can further be generalized to other tasks and modalities, such as to detect evolving tumors or other anatomical substructures. Continued work on the invention is anticipated and it will expand the method and apparatus to detection of further internal brain anatomical structures. Extraction of other classes of structures may require the use of additional features and perhaps a more detailed knowledge domain available in brain atlases will be of assistance.

Although the present invention has been described in terms of specific preferred embodiments, nevertheless modifications and changes will become apparent to those of skill in the art from the teachings herein. Such modifications and changes as will be readily apparent to those skilled in the art are deemed to fall within the purview of the invention as set forth in the claims appended hereto.

### REFERENCES

[1] Brandt, S. McCormick, and J. Ruge, editors. Algebraic multigrid (AMG) for automatic multigrid solution with application to geodetic computations. Inst. for Computational Studies, POB 1852, Fort Collins, Colo., 1982.
[2] L. Breiman. Bagging predictors. Machine Learning, 24(2):123-140, 1996.
[3] D. Collins, A. Zijdenbos, V. Kollokian, J. Sled, N. Kabani, C. Holmes, and A. Evans. Design and construction of realistic digital brain phantom. IEEE MI, 17(3):463-468, 1998.
[4] J. R. Duda and P. Hart, editors. Pattern classification and scene analysis. John Wiley and Sons, New York, 1973.
[5] R. Fergus, P. Perona, and A. Zisserman. Object class recognition by unsupervised scale-invariant learning. CVPR, 2003.
[6] S. Frackowiak, K. Friston, C. Frith, R. Dolan, C. Price, S. Zeki, J. Ashburner, and W. Penny, editors. Human Brain Function. Academic Press, 2003.
[7] M. Galun, E. Sharon, R. Basri, and A. Brandt. Texture segmentation by multiscale aggregation of filter responses and shape elements. ICCV, pages 716-723, 2003.
[8] Y. Ge, R. Grossman, J. Babb, J. He, and L. Mannon. Dirty appearing white matter in Multiple Sclerosis: volumetric MRI and magnetization transfer ratio histogram analysis. AJNR Am J Neuroradiol, 24(10):1935-40, 2003.
[9] G. Gerig, M. Jomier, and M. Chakos. Valmet: A new validation tool for assessing and improving 3d object segmentation. MICCAI, pages 516-523, 2001.
[10] M. Rovaris, M. Rocca, T. Y. I. Yousry, B. Colombo, G. Comi, and M. Filippi. Lesion load quantification on fast-flair, rapid acquisition relaxation-enhanced, and gradientspin echo brain mri scans from multiple sclerosis patients. MRI, 17(8):1105-10, 1999.
[11] A. Shahar and H. Greenspan. A probabilistic framework for the detection and tracking in time of Multiple Sclerosis lesions. IBSI, 2004.
[12] E. Sharon, A. Brandt, and R. Basri. Segmentation and boundary detection using multiscale intensity measurements. CVPR, pages 469-476, 2001.
[13] S. Smith. Fast robust automated brain extraction. Human Brain Mapping, 17(3):143-155, 2002.
[14] K. Van-Leemput, F. Maes, D. Vandermeulen, A. Colcher, and P. Suetens. Automated segmentation of ms lesions by model outlier detection. IEEE MI, 20:677-688, 2001.
[15] S. Warfield, K. Zou, and W. M. Wells. Automatic identification of gray matter structures from MRI to improve the segmentation of white matter lesions. J. of image guided surgery, 1(6):326-338, 1995.
[16] X. Wei, S. Warfield, K. Zou, Y. Wu, X. Li, A. Guimond, J. Mugler, R. Benson, L. Wolfson, H. Weiner, and C. Guttmann. Quantitative analysis of MRI signal abnormalities of brain white matter with high reproducibility and accuracy. JMRI, 15:203-209, 2002.
[17] A. Zijdenbos, R. Forghani, and A. Evans. Automatic pipeline analysis of 3d MRI data for clinical trials: application to MS. IEEE MI, 21:1280-1291, 2002.
[18] Pham, D., Xu, C., Prince, J.: Current methods in medical image segmentation. Annual Review of Biomedical Engineering 2 (2000) 315-337
[19] Rajapakse, J., Kruggel, F.: Segmentation of MR images with intensity inhomogeneities. IVC 16(3) (1998) 165-180
[20] Shattuck, D. W., Sandor-Leahy, S. R., Schaper, K. A., Rottenberg, D. A., Leahy, R. M.: Magnetic resonance image tissue classification using a partial volume model. Neuroimage 13(5) (2001) 856-76
[21] Bezdek, J. C., Hall, L. O., Clarke, L. P.: Review of MRI segmentation techniques using pattern recognition. Medical Physics 20(4) (1993) 1033-1048
[22] Sonka, M. M., Fitzpatrick, J. M., eds.: Handbook of Medical Imaging. SPIE (2000)
[23] Zijdenbos, A., Dawant, B.: Brain segmentation and white matter lesion detection in MRI. Critical Reviews in Biomedical Engineering 22 (1994)
[24] Zeng, X., Staib, L. H., Schultz, R. T., Duncan, J. S.: Segmentation and measurement of the cortex from 3D MRI using coupled surfaces propagation. IEEE MI (1999)
[25] Pham, D., Prince, J.: Robust unsupervised tissue classification in MRI. IEEE Biomedical Imaging Macro to Nano (2004)
[26] Wells, W. M., Grimson, W., Kikinis, R., Jolesz, F. A.: Adaptive segmentation of MRI data. IEEE MI 15 (1996) 429-442
[27] Zhang, Y., Brady, M., Smith, S.: Segmentation of brain MRI through a hidden markov random field model and the expectation-maximization algorithm. IEEE Medical Imaging 20(1) (2001) 45-57
[28] Van-Leemput, K., Maes, F., Vandermeulen, D., Colcher, A., Suetens, P.: Automated segmentation of MS by model outlier detection. IEEE MI 20 (2001) 677-688
[29] Akselrod-Ballin, A., Galun, M., Gomori, J. M., Fillipi, M., Valsasina, P., Brandt, A., R. Basri: An integrated segmentation and classification approach applied to multiple sclerosis analysis. CVPR (2006)
[30] Sharon, E., Brandt, A., Basri, R.: Fast multiscale image segmentation. CVPR (2000) 70-77
[31] Galun, M., Sharon, E., Basri, R., Brandt, A.: Texture segmentation by multiscale aggregation of filter responses and shape elements. ICCV (2003) 716-723
[32] Brandt, A., McCormick, S., Ruge, J., eds.: Algebraic multigrid (AMG) for automatic multigrid solution with application to geodetic computations. Inst. For Computational Studies, POB 1852, Fort Collins, Colo. (1982)
[33] Frackowiak, S., Friston, K., Frith, C., Dolan, R., Price, C., Zeki, S., Ashburner, J., Penny, W., eds.: Human Brain Function. Academic Press (2003)
[34] Vapnik, V., ed.: The Nature of Statistical Learning Theory. Springer-Verlag (1995)
[35] Burkhardt, J.: A markov chain monte carlo algorithm for the segmentation of t1-mr-images of the head. Diploma thesis, Technische Universitat Munchen (2003)
[36] Gerig, G., Jomier, M., Chakos, M.: Valmet: A new validation tool for assessing and improving 3D object segmentation. MICCAI (2001) 516-523

1-35. (canceled)

36. An imaging analysis method for detecting abnormal or anatomical tissues or bone structures, and in particular brain structures comprising the steps of:
a. performing multiscale segmentation by weighted aggregation recursively on imaging data comprised of voxels of tissues or bone structures, and in particular brain structures, adapted for 3D multi-channel and anisotropic data, by creating a graph and recursively coarsening to create a pyramid composed of a plurality of levels with aggregates identified at each level;
b. determining segments from the voxels of the aggregates at each level;
c. extracting a plurality of features from the aggregates at each level including intensity, texture, shape and location for characterizing each of the aggregates;
d. training a classifier composed of multiple decision trees using labeled data;
e. classifying across scale the voxels of the plurality of segments utilizing the trained classifier at a plurality of segmentation levels corresponding to different sized segments;
f. determining from the classifying in step e. segments indicative of abnormal or anatomical tissues or bone structures; and
g. displaying the indication of step f.

37. The imaging analysis method of claim 36 wherein classifying step e. includes a Support Vector Machine classification.

38. The imaging analysis method of claim 36 wherein classifying in step e. is applied to three scales corresponding to small, intermediate, and large segments.

39. The imaging analysis method of claim 36 wherein the imaging data is a 3D multi-channel MR scan.

40. The imaging analysis method of claim 39 wherein the MR scan includes anisotropic data.

41. The imaging analysis method of claim 40 wherein the MR scan is a MR scan of a brain and the tissue structures include multiple sclerosis lesions.

42. The imaging analysis method of claim 39 wherein classifying step e. uses a brain atlas.

43. An imaging analysis apparatus for detecting abnormal or anatomical tissues or bone structures, and in particular brain structures comprising:
a. means for performing multiscale segmentation by weighted aggregation recursively on imaging data comprised of voxels of tissues or bone structures, and in particular brain structures, adapted for 3D multi-channel and anisotropic data, by creating a graph and recursively coarsening to create a pyramid composed of a plurality of levels with aggregates identified at each level;
b. means for determining segments from the voxels of the aggregates at each level;
c. means for extracting a plurality of features from the aggregates at each level including intensity, texture, shape and location for characterizing each of the aggregates;
d. means for training a classifier composed of multiple decision trees using labeled data;
e. means for classifying across scale the voxels of the plurality of segments utilizing the trained classifier at a plurality of segmentation levels corresponding to different sized segments;
f. means for determining from the classification segments indicative of abnormal or anatomical tissues or bone structures; and
g. means for displaying the indication.

44. The imaging analysis apparatus of claim 43 further including a Support Vector Machine classifier.

45. The imaging analysis apparatus of claim 43 the means for classifying includes the applying the classifying to three scales corresponding to small, intermediate, and large segments.

46. The imaging analysis apparatus of claim 43 further including means for obtaining the imaging data as a 3D multi-channel MR scan.

47. The imaging analysis apparatus of claim 46 wherein the MR scan includes anisotropic data.

48. The imaging analysis apparatus of claim 47 wherein the MR scan is a MR scan of a brain and the tissue structures include multiple sclerosis lesions.

49. The imaging analysis apparatus of claim 43 wherein the means for classifying includes a brain atlas.

50. Computer readable medium containing program instructions for performing multiscale segmentation by weighted aggregation recursively on imaging data comprised of voxels of tissues or bone structures, and in particular brain structures, adapted for 3D multi-channel and anisotropic data, by creating a graph and recursively coarsening to create a pyramid composed of a plurality of levels with aggregates identified at each level; determining segments from the voxels of the aggregates at each level; extracting a plurality of features from the aggregates at each level including intensity, texture, shape and location for characterizing each of the aggregates; training a classifier composed of multiple decision trees using labeled data; classifying across scale the voxels of the plurality of segments utilizing the trained classifier at a plurality of segmentation levels corresponding to different sized segments; determining from the classification segments indicative of abnormal or anatomical tissues or bone structures; and displaying the indication.

51. Computer readable medium containing program instructions for performing a medical imaging analysis for detecting anatomical and abnormal tissue structures in imaging data including performing multiscale segmentation by weighted aggregation recursively on imaging data comprised of voxels of tissues or bone structures, and in particular brain structures, adapted for 3D multi-channel and anisotropic data, by creating a graph and recursively coarsening to create a pyramid composed of a plurality of levels with aggregates identified at each level; determining segments from the voxels of the aggregates at each level; classifying a plurality of preselected features for each aggregate of the segments with one of a decision tree-based classifier and a Support Vector Machine classifier to thereby detect tissue structures in the imaging data; and displaying the detected tissue structures.
